(19) United States
(12) Patent Application Publication
(10) Pub. No.: US 2014/0185163 A1
(43) Pub. Date: Jul. 3, 2014

(54) BASE PLATE, AND METHOD OF MANUFACTURING THE SAME AND DISK DRIVE INCLUDING THE SAME

(71) Applicant: SAMSUNG ELECTRO-MECHANICS CO., LTD., Suwon (KR)

(72) Inventors: Tae Young CHOI, Suwon (KR); Il Geun JEON, Suwon (KR)

(73) Assignee: SAMSUNG ELECTRO-MECHANICS CO., LTD., Suwon (KR)

(21) Appl. No.: 13/890,780

(22) Filed: May 9, 2013

(30) Foreign Application Priority Data
Dec. 27, 2012 (KR) 10-2012-0155303

(51) Int. Cl. G11B 33/00; B21D 22/30; B21D 22/20

(52) U.S. Cl. CPC G11B 33/00; B21D 22/206; B21D 22/30
USPC 360/99.08; 72/360; 248/346.01

(57) ABSTRACT

There is provided a base plate including a body part formed of a metal plate, a pocket part including a recess formed in one surface of the body part by decreasing a thickness of the body part, a center plate part forming the pocket part and corresponding to the recess, a pocket periphery part forming the body part in a periphery of the pocket part, and a pocket edge part formed between the pocket periphery part and the center plate part and having a thickness different from that of the center plate part, wherein a height from a bottom surface of the body part to a top surface of the center plate part is identical to a height of the pocket periphery part, and a thickness of the pocket periphery part is greater than a thickness of the center plate part.

### CROSS-REFERENCE TO RELATED APPLICATIONS

This application claims the priority of Korean Patent Application No. 10-2012-0155303 filed on Dec. 27, 2012, in the Korean Intellectual Property Office, the disclosure of which is incorporated herein by reference.

### BACKGROUND OF THE INVENTION

1. Field of the Invention

The present invention relates to a base plate, and a method of manufacturing the same and a disk drive including the same.

2. Description of the Related Art

A hard disk drive (HDD) reads data stored on a disk or writes data to a disk using a magnetic head.

A base plate of the hard disk drive has a head driver, that is, a head stack assembly (HSA), capable of moving a position of the magnetic head on the disk, installed thereon.

Generally, a base plate provided in the hard disk drive is manufactured by die-casting aluminum (Al) and then removing burrs, or the like, generated due to the die-casting, therefrom.

In addition, recently, in accordance with demand for miniaturization and thinning of hard disk drives, a base plate has been manufactured by performing plastic working on a steel-based thin plate (a steel sheet) having a reduced thickness.

In manufacturing the base plate, there is a need to allow a circuit component formed on a printed circuit board to be received in a groove of the steel sheet to thereby miniaturize and thin the entire hard disk drive.

Particularly, unlike a die-casting method, in the case of performing plastic working on a steel sheet, as a thickness of the steel sheet is reduced, it may be difficult to perform plastic working thereon.

The following Patent Document 1 discloses a method of performing embossing on a housing of a sleeve, but does not disclose a structure in which a recess is formed in abase plate and a circuit element of a printed circuit board is received in the recess in order to decrease a thickness of a disk drive as disclosed in the present invention.

In addition, the following Patent Document 2 discloses a burring part protruded by processing a rotor frame using a press in order to determine a position of a permanent magnet, but does not disclose a structure in which a circuit element of a printed circuit board is received in a recess of a base plate having a uniform thickness as disclosed in the present invention.

### Related Art Document

(Patent Document 1) Japanese Patent Laid-open Publication No. 2008-303989
(Patent Document 2) Japanese Patent Laid-open Publication No. 2004-282912

### SUMMARY OF THE INVENTION

An aspect of the present invention provides a base plate including a pocket part having a recess formed in one surface of a metal plate by decreasing a thickness of the metal plate.

An aspect of the present invention also provides a method of manufacturing a base plate including a pocket part having a recess formed in one surface of a metal plate by decreasing a thickness of the metal plate.

An aspect of the present invention also provides a disk drive including a base plate including a pocket part having a recess formed in one surface of a metal plate by decreasing a thickness of the metal plate and a printed circuit board on which a circuit component received in the recess is mounted.

According to an aspect of the present invention, there is provided a base plate including: a body part formed of a metal plate; a pocket part including a recess formed in one surface of the body part by decreasing a thickness of the body part; a center plate part forming the pocket part and corresponding to the recess; a pocket periphery part forming the body part in a periphery of the pocket part; and a pocket edge part formed between the pocket periphery part and the center plate part and having a thickness different from that of the center plate part, wherein a height from a bottom surface of the body part to a top surface of the center plate part is identical to a height of the pocket periphery part, and a thickness of the pocket periphery part is greater than a thickness of the center plate part.

A difference between the thickness of the pocket periphery part and the thickness of the center plate part may correspond to a depth of the recess.

The pocket edge part may be tapered from the pocket periphery part toward the center plate part.

When viewed from a cut surface of the body part, a grain flow in the pocket edge part may be directed from the pocket periphery part toward the center plate part.

The grain flow in the pocket edge part may be discontinuous.

When viewed from a cut surface of the body part, inclusions in the pocket edge part are directed from the pocket periphery part toward the center plate part.

Density of metal particles in the pocket periphery part may be lower than that in the pocket edge part.

Density of metal particles in the body part may be lower than that in the edge pocket part.

A tooling mark may be formed on the top surface of the center plate part corresponding to the recess.

A step may be formed on the top surface of the center plate part corresponding to a boundary of the recess.

According to another aspect of the present invention, there is provided a method of manufacturing a base plate, including: performing plastic working on a rolled steel sheet to only allow a portion of a metal plate to protrude, the protruding portion of the metal plate having a height lower than a thickness of the metal plate; and removing the protruding portion of the metal plate from the metal plate, wherein a pocket part having a recess formed therein is formed in a surface of the metal plate opposite to the protruding portion, a height from a bottom surface of the metal plate to a top surface of the pocket part is identical to a height of a pocket periphery part, and a thickness of the pocket periphery part is greater than that of the center plate part of the pocket part.

The metal plate may protrude in one direction by press working.

The method of may further include performing press working such that a pocket edge part is formed between the center plate part and the pocket periphery part so as to have a thickness different from that of the center plate part and be tapered toward the center plate part.

The protruding portion of the metal plate may be removed by at least one of a milling method, a grinding method, and an electro-polishing method.

According to another aspect of the present invention, there is provided a disk drive: the base plate as described above; a printed circuit board on which a circuit component received in the recess of the pocket part is mounted; and a spindle motor fixed to the base plate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic exploded perspective view of a disk drive according to an embodiment of the present invention;

FIG. 2 is a schematic cross-sectional view showing a portion of the disk drive according to the embodiment of the present invention;

FIG. 3 is an enlarged cross-sectional view of a base plate in portion A of FIG. 2;

FIGS. 4 and 5 are schematic cross-sectional views respectively illustrating a cut-away surface of the base plate according to the embodiment of the present invention;

FIG. 6 is a schematic cross-sectional view of a cut-away surface illustrating a base plate according to another embodiment of the present invention; and

FIGS. 7 and 8 are schematic views illustrating a method of manufacturing a base plate according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

### Disk Drive

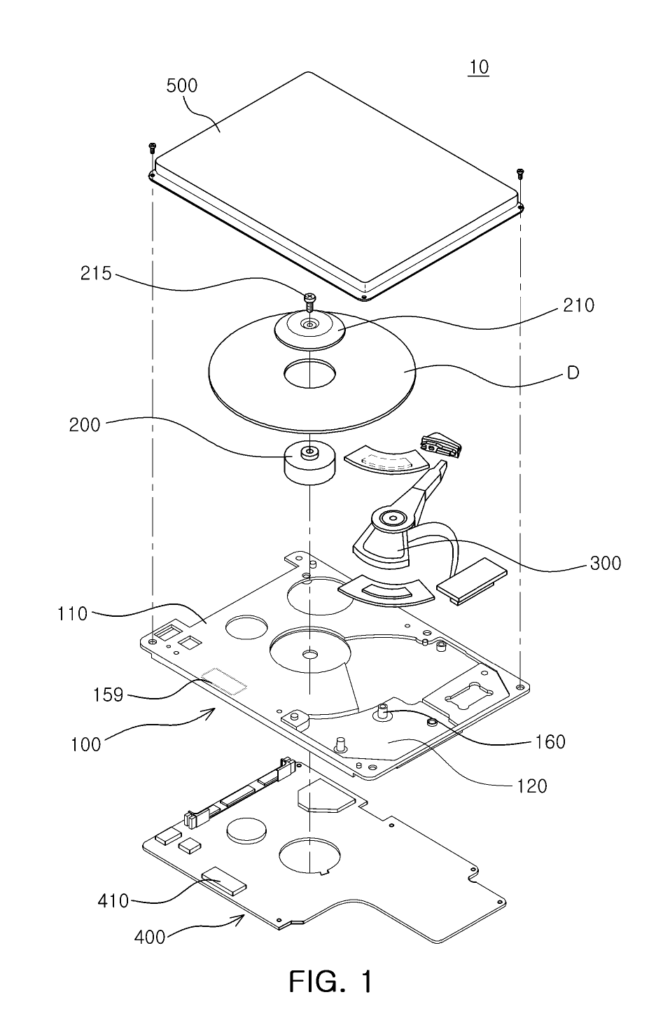

FIG. 1 is a schematic exploded perspective view of a disk drive according to an embodiment of the present invention.

A disk drive 10 according to the embodiment of the present invention may include a base plate 100 for a disk drive (hereinafter, referred to as a ‘base plate’), a printed circuit board 400, and a spindle motor 200.

In addition, the disk drive 10 may include a head driver 300 having a magnetic head (not shown) mounted thereon and moving the magnetic head to a surface of a disk D so as to read information from the disk D and write information to the disk D.

The base plate 100 may form an internal space and an exterior of the disk drive 10 together with a cover plate 500. The spindle motor 200 allowing the disk D to be rotatable and the head driver 300 may be embedded in the internal space.

The base plate 100 may be manufactured by performing plastic working such as press working, or the like, on a thin metal plate. In the case in which the base plate 100 is manufactured by plastic working, a cost required for forming a mold and a degree of freedom of deformation may be higher and a processing time may be significantly decreased, as compared with the case in which the base plate 100 is manufactured by die-casting.

Since a base body (hereinafter referred to as “a body part”) 110 according to the embodiment of the present invention may be manufactured by press working, a processing time and energy consumption are significantly decreased, whereby production capability may be improved.

Meanwhile, as a material of the base plate 100, a cold rolled steel sheet (SPCC, SPCE, or the like), a hot rolled steel sheet, stainless steel, or lightweight alloy steel sheet such as a boron or magnesium alloy, or the like, may be used.

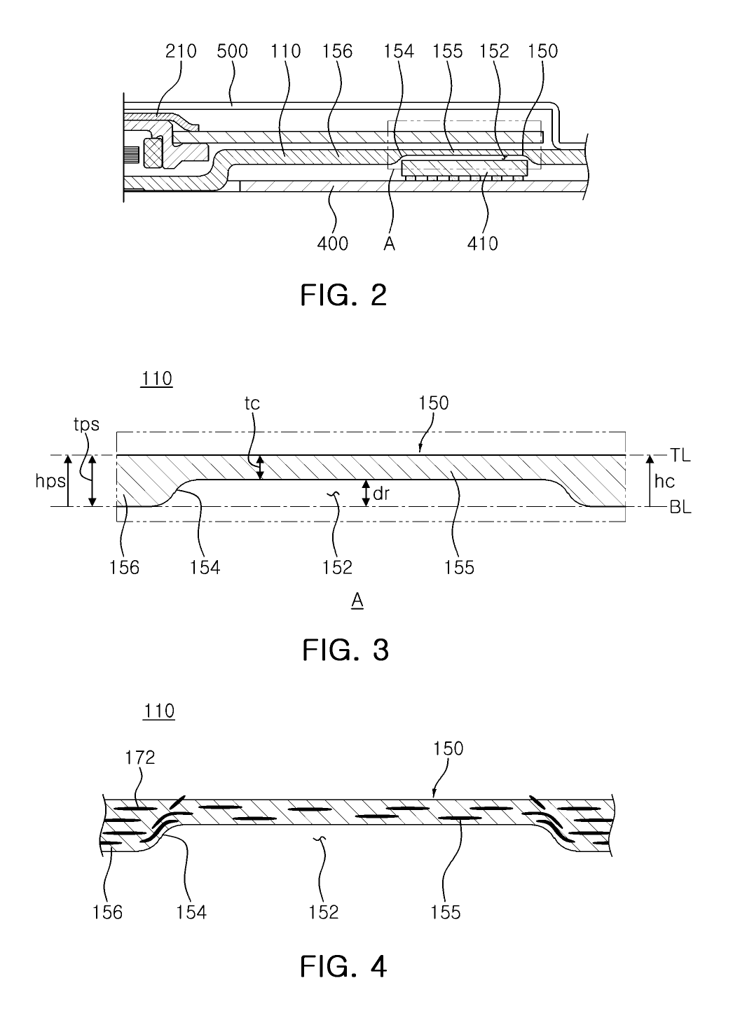

The base plate 100 according to the embodiment of the present invention may include a pocket part 150 formed therein, the pocket part 150 having a circuit component 410 of the printed circuit board 400 received therein. The base plate 100 will be described below with reference to FIGS. 2 through 6.

The disk D seated on the spindle motor 200 may be disposed in the internal space between the base plate 100 and the cover plate 500.

A top surface of the body part 110 of the base plate 100 may have a height which is varied according to a component received in the internal space. A head seating part 120 on which the head driver 300 is disposed may be formed in a position of the body part 110 in which the top surface thereof is formed to have a low height.

Here, the head seating part 120 is positioned on a lower portion of a step of the body part 110 to allow the head driver 300 to repeatedly rotate so as to read data from the disk D and write the data to the disk D.

The spindle motor 200, provided to rotate the disk D, may be fixedly mounted in a central portion of the body part 110. Here, the spindle motor 200 may include a clamp 210 coupled to an upper end portion thereof by a screw 215 in order to firmly fix the disk D thereto.

In addition, although a configuration in which a single disk D is mounted on the spindle motor 200 is shown in FIG. 1, this configuration is merely provided by way of an example. That is, two or more disks D may be mounted on the spindle motor 200. In the case in which a plurality of disks D are mounted as described above, a ring shaped spacer for maintaining an interval between the disks D may be disposed between the disks D.

The head driver 300 may be referred to as a head stack assembly (HAS) and have the magnetic head (not shown) mounted thereon and move the magnetic head (not shown) to a predetermined position to write data to the disk D or read the data written in the disk D.

In addition, the head driver 300 may be coupled to the base plate 100 in such a manner that the head driver 300 may rotate around a pivot shaft 160 of the head seating part 120 of the base plate 100.

### Base Plate

FIG. 2 is a schematic cross-sectional view showing a portion of the disk drive according to the embodiment of the present invention; and FIG. 3 is an enlarged cross-sectional view of a base plate in portion A of FIG. 2.

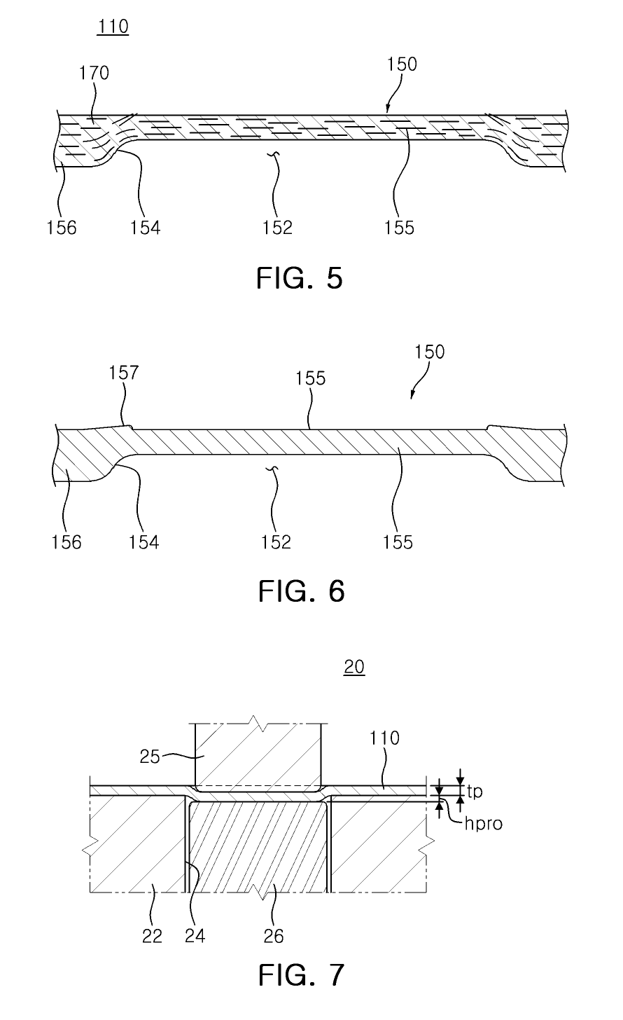

In addition, FIGS. 4 and 5 are schematic cross-sectional views respectively illustrating a cut-away surface of the base plate according to the embodiment of the present invention; and FIG. 6 is a schematic cross-sectional view illustrating a cut-away surface of a base plate according to another embodiment of the present invention.

The base plate 100 according to the embodiment of the present invention refers to a housing forming the exterior of the disk drive, together with the cover plate 500 in the hard disk drive.

Referring to FIGS. 2 and 3, the base plate 100 according to the embodiment of the present invention may include the body part 110, the pocket part 150, a center plate part 155, a pocket periphery part 156, and a pocket edge part 154.

The body part 110 may be formed of a metal plate and be formed by performing plastic deformation on a steel sheet as described above. More specifically, the top surface of the body part may have a variable height or a shape of the pocket part 150, or the like, may be manufactured through press working.

In addition, the body part 110, formed of a thin metal plate, may include a recess formed by allowing a portion of the body part 110 to protrude upwardly through press working rather than forging processing and performing a planarization process of removing the protruding portion in order to decrease a thickness of the thin metal plate.

That is, the embodiment of the present invention is different from a technology of forming the recess in the base plate through forging processing.

The pocket part 150 may be formed by the recess 152 that is formed by decreasing a thickness of a surface of the body part 110. A plate of the body part 110 corresponding to the recess 152 in the pocket part 150 may be defined as the center plate part 155.

The body part 110 may be divided into the pocket part 150, the pocket edge part 154, and the pocket periphery part, 156 based on the pocket part 150.

The pocket part 150 may be apart receiving the circuit component 410 mounted on the printed circuit board 400 therein, and a height hc from a bottom surface (BL) of the body part 110 to a top surface (TL) of the center plate part 155 may be identical to a height hps of the pocket periphery part 156.

The height hc from the bottom surface (BL) of the body part 110 to the top surface (TL) of the center plate part 155 may be a thickness tps of the pocket periphery part 156.

Here, the thickness tps of the pocket periphery part 156 may be greater than a thickness tc of the center plate part 155, and a difference between the thickness tps of the pocket periphery part 156 and the thickness tc of the center plate part 155 may correspond to a depth dr of the recess 152.

The pocket edge part 154 may be formed between the pocket periphery part 156 and the center plate part 155 and may have a thickness different from that of the center plate part 155.

The pocket edge part 154 may be formed by deforming the body part 110 with a punch 25 (See FIG. 7) in a plastic working process. An edge part of the punch 25 is tapered, such that the pocket edge part 154 corresponding to the edge part of the punch 25 may be tapered from the pocket periphery part 156 toward the center plate part 155.

A tooling mark 159 (See FIG. 1) may be formed on the top surface of the center plate part 155 corresponding to the recess 152, due to a process such as a milling process, or the like, performed to planarize the pocket periphery part 156.

In addition, as shown in FIG. 6, a step 157 may be formed on the top surface of the center plate part 155 corresponding to the recess 152.

The tooling mark 159 and the step 157 may allow a direction in which the circuit component 410 is positioned, to be recognized at the time of assembling the printed circuit board 400, whereby an assembly defect may be decreased.

Meanwhile, as described above, as a material of the base plate 100, a cold rolled steel sheet (SPCC, SPCE, or the like), a hot rolled steel sheet, stainless steel, or lightweight alloy steel sheet such as a boron or magnesium alloy, or the like, may be used.

The lightweight alloy steel sheet may be formed of a material having excellent machinability and may be easily deformed during press forming. Here, as shown in FIG. 4, in the stainless steel that is a raw material, inclusions may be extended in a lengthwise direction. The inclusions 172 may facilitate cutting operations at the time of cutting the base plate 100.

FIG. 4 schematically shows the inclusions 172 present in a cross section of the base plate after the pocket part 150 is formed by performing plastic working on the stainless steel having a thickness corresponding to that of the body part 110 of the base plate.

When viewed from a cut surface of the body part 110, the inclusions 172 present in the pocket edge part 154 may be directed from the pocket periphery part 156 toward the center plate part 155.

In addition, the inclusions 172 may have high density, particularly in the pocket edge part 154, and a cut shape of the inclusions 172 may be seen from the top surface of the body part 110 corresponding to the pocket edge part 154.

FIG. 5 is a schematic cross-sectional view showing a direction of a grain flow 170 in a cross section of the base plate after the pocket part 150 is formed by performing plastic working on the stainless steel having a thickness corresponding to that of the body part 110 of the base plate. Here, the direction of the grain flow 170 may be substantially similar to that of the inclusions 172.

The grain flow 170 may refer to a cutting line of a material appearing when the stainless steel is cut off.

Meanwhile, since the pocket edge part 154 may be compressed by the press working, density of metal particles in the pocket periphery part 156 may be lower than that in the pocket edge part 154. In addition, density of metal particles in the body part 110 may be lower than that in the pocket edge part 154.

### Method of Manufacturing Base Plate

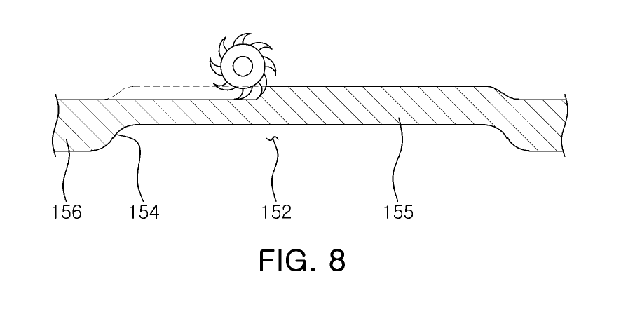

FIGS. 7 and 8 are schematic views illustrating a method of manufacturing a base plate according to an embodiment of the present invention.

Referring to FIGS. 7 and 8, plastic working may be performed on a rolled steel sheet to only allow a portion of the body part to protrude, and in this case, the protruding portion of the base part 110 may have a height hpro lower than a thickness tp of the base part 110. Here, the base part 110 may be formed of a metal plate.

A press device 20 for performing plastic working on the rolled steel sheet may include a fixed jig 22 provided with a hole 24 for forming the pocket part.

An intermediate jig 26 may be disposed within the hole 24 for forming the pocket part inwardly of the fixed jig 22.

The intermediate jig 26 may define an upper limit of the height hpro of the protruding portion of the base part 110 and have a top surface disposed lower than a top surface of the fixed jig 22 by an amount equal to the height hpro of the base part 110 protruding inwardly of the hole 24.

After the fixed jig 22 and the intermediate jig 26 are disposed as described above and the base part 110 is disposed, the base part 110 may be pressed toward the intermediate jig 26 using the punch 25 having a shape corresponding to that of the recess in the pocket part.

Here, the base part 110 is subjected to the press working, such that the pocket part may protrude in one direction.

When the base part 110 is pressed using the punch 25 as described above, the base part 110 may protrude to have the height hpro smaller than the thickness tp of the base part 110.

Then, the protruding portion of the base part 110 is removed from the base part 110.

When the protruding portion is removed from the base part 110, a surface of the base part 110 opposite to the protruding portion may be the pocket part having the recess formed therein.

When the above-mentioned process is performed, the height hc from the bottom surface (BL) of the base part 110 to the top surface (TL) of the pocket part 150 is identical to the height hps of the pocket periphery part 156, and the thickness tps of the pocket periphery part 156 may be greater than the thickness tc of the center plate part 155, as shown in FIG. 3.

Meanwhile, the edge part of the punch 25 may be tapered. Therefore, the pocket edge part 154, an edge part of the pocket part, may be formed between the center plate part 155 and the pocket periphery part 156 to have a thickness different from that of the center plate part 155 and may be tapered toward the center plate part 155.

After the base part 110 is subjected to the press working, the protruding portion of the base part 110 may be removed by at least one of a milling method, a grinding method, and an electro-polishing method.

As set forth above, the base plate, and the method of manufacturing the same and the disk drive including the same according to the embodiments of the present invention have the following effect.

That is, in the case of decreasing a thickness of a steel sheet of the base plate by a die-casting method, a mold needs to be replaced. Therefore, according to the embodiment of the present invention, a manufacturing process of the base plate may be facilitated and manufacturing costs of the base plate may be decreased, as compared with the case using die-casting method.

In addition, since a portion of the circuit component may be inserted into the recess formed in the base plate, the overall size of a thinned disk drive may be further decreased.

While the present invention has been shown and described in connection with the embodiments, it will be apparent to those skilled in the art that modifications and variations can be made without departing from the spirit and scope of the invention as defined by the appended claims.

What is claimed is:

1. A base plate comprising:
a body part formed of a metal plate;
a pocket part including a recess formed in one surface of the body part by decreasing a thickness of the body part;
a center plate part forming the pocket part and corresponding to the recess;
a pocket periphery part forming the body part in a periphery of the pocket part; and
a pocket edge part formed between the pocket periphery part and the center plate part and having a thickness different from that of the center plate part,
wherein a height from a bottom surface of the body part to a top surface of the center plate part is identical to a height of the pocket periphery part, and
a thickness of the pocket periphery part is greater than a thickness of the center plate part.

2. The base plate of claim 1, wherein a difference between the thickness of the pocket periphery part and the thickness of the center plate part corresponds to a depth of the recess.

3. The base plate of claim 1, wherein the pocket edge part is tapered from the pocket periphery part toward the center plate part.

4. The base plate of claim 1, wherein when viewed from a cut surface of the body part, a grain flow in the pocket edge part is directed from the pocket periphery part toward the center plate part.

5. The base plate of claim 4, wherein the grain flow in the pocket edge part is discontinuous.

6. The base plate of claim 1, wherein when viewed from a cut surface of the body part, inclusions in the pocket edge part are directed from the pocket periphery part toward the center plate part.

7. The base plate of claim 1, wherein density of metal particles in the pocket periphery part is lower than that in the pocket edge part.

8. The base plate of claim 1, wherein density of metal particles in the body part is lower than that in the pocket edge part.

9. The base plate of claim 1, wherein a tooling mark is formed on the top surface of the center plate part corresponding to the recess.

10. The base plate of claim 1, wherein a step is formed on the top surface of the center plate part corresponding to a boundary of the recess.

11. A method of manufacturing a base plate, comprising:
performing plastic working on a rolled steel sheet to only allow a portion of a metal plate to protrude, the protruding portion of the metal plate having a height lower than a thickness of the metal plate; and
removing the protruding portion of the metal plate from the metal plate,
wherein a pocket part having a recess formed therein is formed in a surface of the metal plate opposite to the protruding portion,
a height from a bottom surface of the metal plate to a top surface of the pocket part is identical to a height of a pocket periphery part, and
a thickness of the pocket periphery part is greater than that of the center plate part of the pocket part.

12. The method of claim 11, wherein the metal plate protrudes in one direction by press working.

13. The method of claim 11, further comprising performing press working such that a pocket edge part is formed between the center plate part and the pocket periphery part so as to have a thickness different from that of the center plate part and be tapered toward the center plate part.

14. The method of claim 11, wherein the protruding portion of the metal plate is removed by at least one of a milling method, a grinding method, and an electro-polishing method.

15. A disk drive comprising:
the base plate of claim 1;
a printed circuit board on which a circuit component received in the recess of the pocket part is mounted; and
a spindle motor fixed to the base plate.
